(19) United States
(12) Patent Application Publication
(10) Pub. No.: US 2003/0079506 A1
(43) Pub. Date: May 1, 2003

(54) Dryer for floor mats

(76) Inventor: Jon Kolquist, Hermantown, MN (US)

Correspondence Address: Christopher J. McDonald, Esq., HOFFMAN, WASSON & GITLER, PC, 2361 Jefferson Davis Highway, Suite 522, Arlington, VA, 22202, US

(21) Appl. No.: 10/155,006

(22) Filed: May 28, 2002

Related U.S. Application Data
(60) Provisional application No. 60/330,640, filed on Oct. 26, 2001.

(51) Int. Cl. F26B 19/00; D06F 9/00

(52) U.S. Cl. 68/70; 34/69; 34/60

(57) ABSTRACT

The invention is a portable machine using two pairs of rollers to squeeze water from a wet floor mat. A motor provides a driving force to the lower rollers and the upper rollers are driven by frictional engagement with the lower rollers. After passing through the two sets of rollers, the mat exits the back of the machine and falls into a basket. After processing by the machine, the car mat is substantially dry and able to be placed into a car interior without fear of mold formation.

### BACKGROUND OF THE INVENTION

The instant application is based upon provisional patent application Serial No. 60/330,640, filed Oct. 26, 2001.

Floor mats in a vehicle are used to protect the interior of the automobile. They often match the color of the interior and are subjected to the most wear and tear from the occupants of the vehicle. When completely worn out, they can be easily replaced, unlike the interior carpet.

Occupants of the vehicle often cause the car mats to become dirty, stained and in need of cleaning. When the exterior of the car is washed, the vehicle owner may want to have the car floor mats cleaned. This is especially true when a car is “detailed”, and both the interior and exterior of a car are thoroughly cleaned.

Floor mats are essentially pieces of carpeting and are cleaned similar to carpeting. After cleaning, the floor mat is wet and needs to be dried before being placed back in the vehicle because, once in the vehicle, the enclosed environment of the vehicle interior will cause the mat to dry slowly. In this time, the floor mat can cause a musty, moldy odor in the vehicle.

It is therefore necessary to have an apparatus for drying a floor mat after a cleaning process.

It is an object of the invention to provide a machine for drying car mats after they have been cleaned.

It is another object of the invention to provide a machine for drying car mats that is mobile.

It is another object of the invention to provide a machine for drying car mats that can be coin operated.

It is yet another object of the invention to provide a machine for drying car mats that is inexpensive to manufacture and easy to use.

These and other objects of the invention will become apparent to one of ordinary skill in the art after reading the disclosure of the invention.

### SUMMARY OF THE INVENTION

The invention is a portable machine using two pairs of rollers to squeeze water from a wet floor mat. A motor provides a driving force to the lower rollers and the upper rollers are driven by frictional engagement with the lower rollers. After passing through the two sets of rollers, the mat exits the back of the machine and falls into a basket. After processing by the machine, the car mat is substantially dry and able to be placed into a car interior without fear of mold formation.

### BRIEF DESCRIPTION OF THE DRAWINGS

FIG. 1 is a exploded view of the housing of the dryer for floor mats;

FIG. 2a is a left side view of the dryer with the left panel removed;

FIG. 2b is a front view of the dryer;

FIG. 2c is a right side view of the dryer with the right panel removed;

FIG. 3a is an exploded view of the bottom roller assembly;

FIG. 3b is a view of the sprocket and spring slack adjuster; and

FIG. 4 is an exploded view of the top roller assembly.

### DETAILED DESCRIPTION OF THE INVENTION

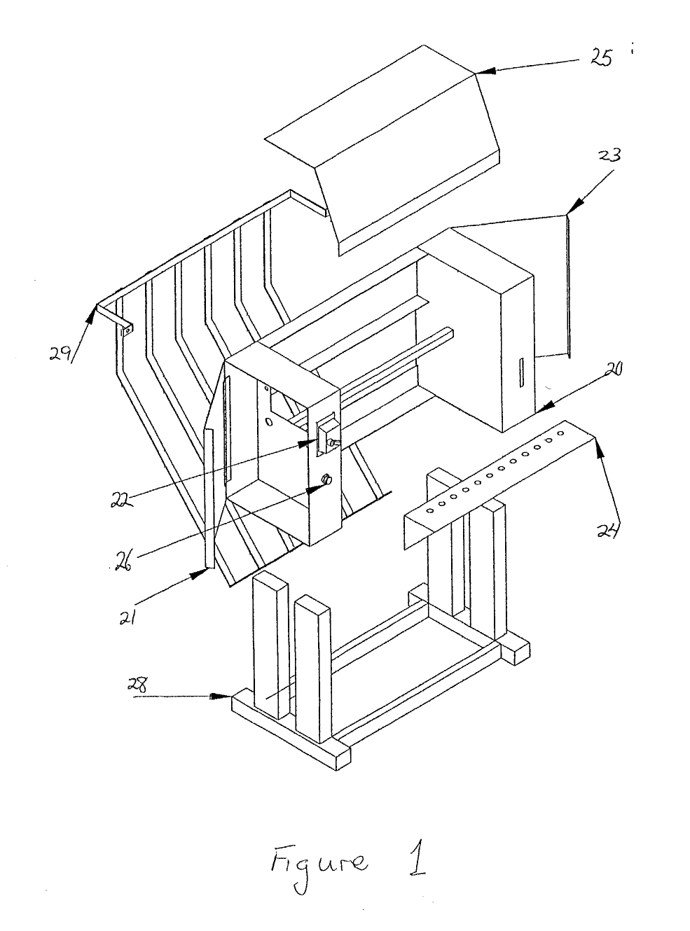

The housing of the mat dryer for car floor mats is seen in the exploded view of FIG. 1. A frame 20 is supported by legs 28. A left panel 21 is attached to the left side of the frame 20 and a right panel 23 is attached to the right side of the frame 20. A cover 24 is attached to the front of the frame 20 to form an enclosure. The left panel is equipt with an On/Off switch 22 and an Emergency On/Off switch 26. The On/Off switch 22 can be connected to a coin slot to make the machine coin operated.

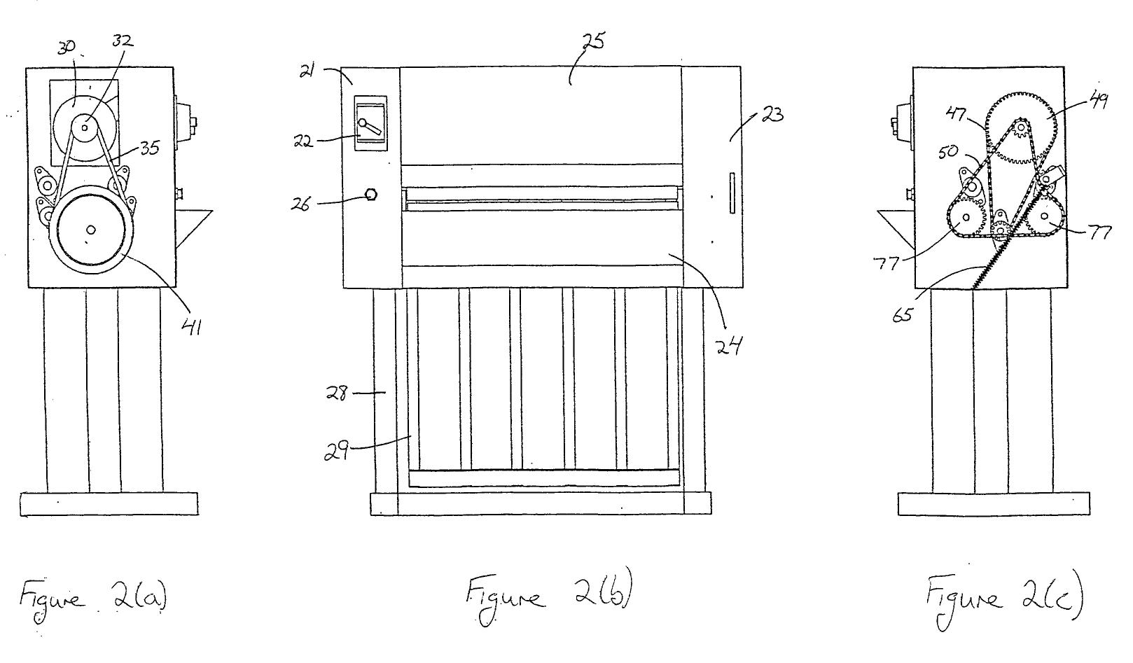

A view of the left side of the dryer for car floor mats is seen in FIG. 2a. A motor 30 is attached to the Left side of the frame 20 and drives a pulley 32. A V-belt 35 connects the driven pulley 32 to an eight-inch pulley 41.

The front of the dryer for car floor mats is shown in FIG. 2b. The legs 28 can be supported upon leg levelers. A basket 29 receives the mats after passing through the device. The eight-inch pulley 41 driven by the motor 30 is attached to a drive shaft 43 extending across the length of the dryer to the right side, as will be described later. An on/off switch 37 operates the motor 30 and the front cover 24 of the enclosure has a feeder slot 25 for receiving wet car floor mats.

The right side of the device can be seen in FIG. 2c. A 12-tooth sprocket 45 is connected to the right end of drive shaft 43 driven by motor 30. A chain 47 connects the sprocket 45 to a gear reducer 49. The gear reducer 49 is connected to sprockets 77, one connected to each of the bottom rollers by way of drive chain 50. A slack adjuster 63, tensioned by a spring 65, insures the sprockets 77 are efficiently driven by the drive chain 50.

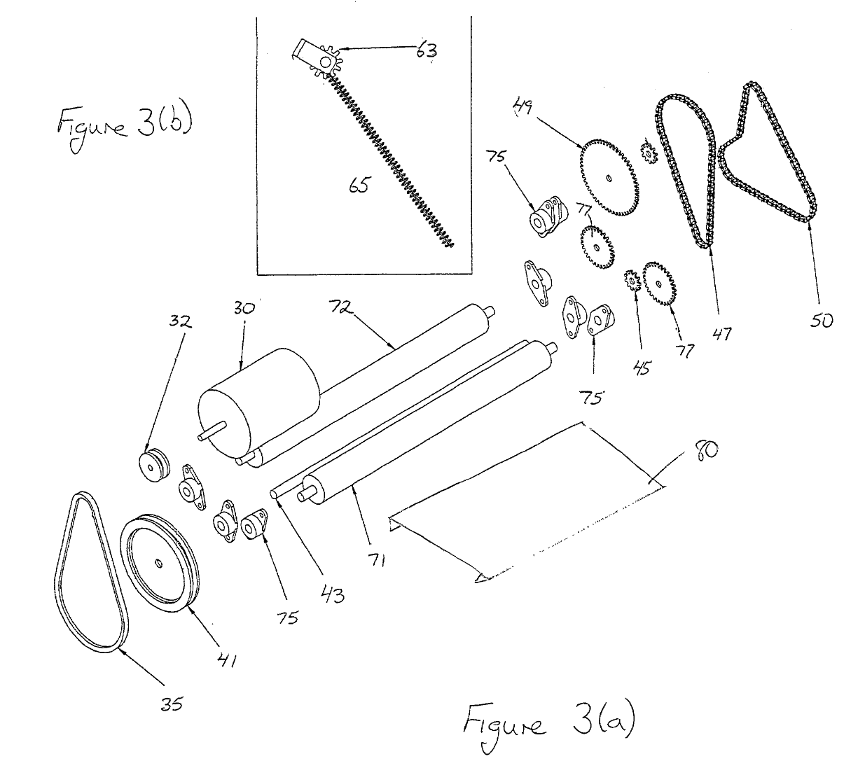

The bottom roller assembly is clearly seen in FIG. 3. A front roller 71 and rear roller 72 are identical 2½ inch outer diameter rollers and held to the sides of the frame 20 by ¾ inch flange bearing 75. Attached to the right side of both the front roller 71 and rear roller 72 are 28-tooth sprocket 77. Between the rollers is the drive shaft 43 driven by the eight-inch pulley 41. On the right side of the drive shaft 43 is the 12-tooth sprocket 45, as was described in reference to FIG. 2. Between the front and rear rollers 71, 72 is a steel plate 80 supporting the car floor mat as it travels between the rollers. The slack adjuster and tensioning spring 65 are best seen in FIG. 3b.

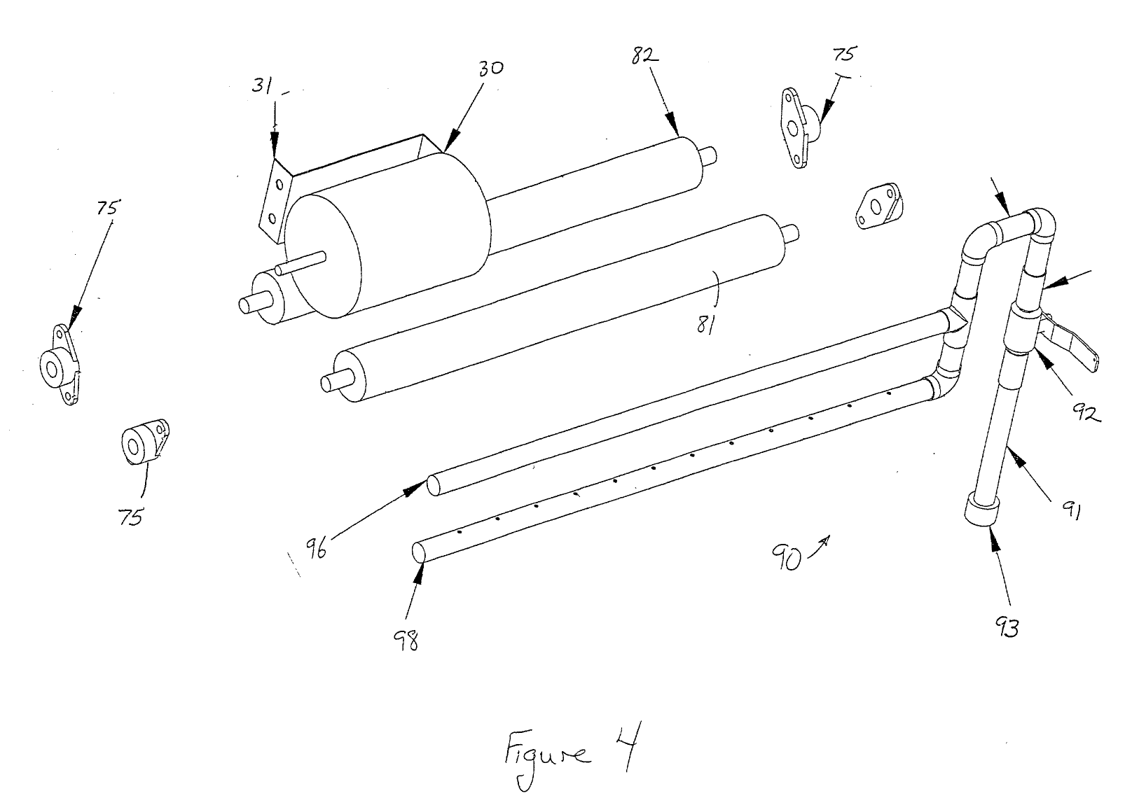

The top rollers are seen in reference to FIG. 4. A front top roller 81 and a rear top roller 82 are spaced from each other the same distance as the front and rear bottom rollers 71, 72. The top rollers 81, 82, like the bottom rollers 71, 72, are attached to the sides of the frame 20 by a ¾ inch flange bearing 75. The top rollers 81, 82 are driven by frictional contact with the bottom rollers 71, 72. All of the rollers are formed by a steel shaft with a rubber body. The rubber body has enough resilience to allow the passage of a floor mat between the upper and lower roller of each pair but apply enough pressure to remove water from the mats.

A water assembly 90 is positioned within the machine between the front cover 25 and the front top and bottom rollers 71, 81. The water assembly has a pipe 91 provided with a valve 92 for controlling the flow of water. The base of the pipe 91 is provided with a swivel joint 93 allowing the assembly to be pivoted out of the machine when the front guide panel 24 and top panel 25 are opened. The pipe 91 leads to a top sprayer 96 and bottom sprayer 98. A mat passes between the top sprayer 96 and bottom sprayer 98 and jets in the top and bottom sprayers are directed toward the mat. If the mat is already cleaned and wet before entering the machine, the spray assembly can be turned off.

While the invention has been described with reference to a preferred embodiment, variations and modifications would be apparent to one of ordinary skill in the art without departing from the scope of the invention. The invention encompasses such variations and modifications.

I claim:

1. A dryer for car mats comprising:
a housing, said housing having a front, a back, a top, a bottom, a left side and a right side,
an inlet in said front of said housing,
an outlet in said back of said housing, and
a first set of rollers in said housing, said first set of rollers comprising a top roller and a bottom roller.

2. The dryer of claim 1, further comprising:
a second set of rollers in said housing, said second set of rollers comprising a top roller and a bottom roller, and
said second set of rollers located behind said first set of rollers.

3. The dryer of claim 1, wherein said first set of rollers having a metal shaft and a rubber body.

4. The dryer of claim 2, wherein said second set of rollers having a metal shaft and a rubber body.

5. The dryer of claim 1, further comprising a basket for receiving floor mats from said outlet.

6. The dryer of claim 5, wherein said basket is angled to move said floor mats to the front of said dryer.

7. The dryer of claim 1, wherein said dryer is coin operated.
